(19) United States
(12) Patent Application Publication
(10) Pub. No.: US 2023/0108870 A1
(43) Pub. Date: Apr. 6, 2023

(54) Dark Colored Laser Transparent Composition and Molded Articles Made Therefrom

(71) Applicant: Celanese International Corporation, Irving, TX (US)

(72) Inventor: Kent Miller, Nicholasville, KY (US)

(21) Appl. No.: 17/886,076

(22) Filed: Aug. 11, 2022

Related U.S. Application Data
(60) Provisional application No. 63/232,716, filed on Aug. 13, 2021.

(51) Int. Cl. C08L 67/02; C08J 5/12; G01N 21/59; B29C 65/16; B29C 65/00

(52) U.S. Cl. CPC C08L 67/02; C08J 5/121; G01N 21/59; B29C 65/16; B29C 66/7392; B29C 66/721; C08L 2205/025; C08L 2310/00; C08J 2367/02; C08J 2467/02; B29K 2067/006

(57) ABSTRACT

Polyester polymer compositions are described containing a blend of coloring agents and optionally reinforcing fibers. The polyester polymer, for instance, can be polybutylene terephthalate. The polymer composition is particularly formulated in order to be substantially transparent at specific wavelengths of light. Consequently, the polyester polymer composition is well suited for use in laser transmission welding in which a laser beam passes through the polymer composition and forms a weld on an adjoining surface.

### RELATED APPLICATIONS

The present application is based upon and claims priority to U.S. Provisional Patent Application Ser. No. 63/232,716, having a filing date of Aug. 13, 2021, which is incorporated herein by reference in its entirety.

### BACKGROUND

Engineering thermoplastics and elastomeric materials are often used in numerous and diverse applications in order to produce molded parts and products. For instance, polyester polymers and polyester elastomers are used to produce all different types of molded products, such as injection molded products, blow molded products, and the like. Polyester polymer compositions, for instance, can be formulated in order to be chemically resistant, to have excellent strength properties and, can be flexible when containing a polyester elastomer. Of particular advantage, polyester polymers can be melt processed due to their thermoplastic nature. In addition, polyester polymers can be recycled and reprocessed.

Polyester polymers are particularly well suited to producing molded articles of any suitable shape or dimension. The molded articles can be made through injection molding, thermoforming, or any other suitable melt processing method. In many applications, the molded article is then bonded to adjacent materials when incorporated into a product or system. Bonding can occur through the use of an adhesive, the use of ultrasonic energy, or using a mechanical fastener. In certain applications, laser welding is the preferred method for bonding or attaching two parts together. The use of laser welding is not only relatively simple but is also very precise and does not typically cause any structural damage to the parts.

In one particular type of laser welding, often referred to as laser transmission welding, two polymer articles are placed in contact with each other and laser energy penetrates and passes through the first molded article and is then absorbed by the second article causing a weld to form. In this type of welding, for instance, the first molded article is formulated to be laser-transparent. The first molded article, for instance, should permit a significant portion of the laser light to pass through the article and then be absorbed by the second molded article. When the laser energy contacts the second molded article, the second molded article absorbs the energy, causing a localized increase in temperature which causes the polymer material used to form the second molded article to soften and flow. A weld then forms which can then bond the laser-transparent molded article to the laser-absorbent molded article.

For laser transmission welding to be successful, the laser-transparent molded article should have a relatively high laser transparency at the wavelength at which the laser beam operates. Problems have been experienced, however, in producing laser-transparent molded articles from polyester polymers that include inorganic and/or organic colorants. The colorants, for instance, can absorb and reflect different wavelengths of light which adversely interferes with the transparency characteristics of the molded article. This is especially true when trying to produce molded articles having a dark or black color. For instance, carbon black is typically used as a standard black pigment. Carbon black can absorb significant amounts of light which can drastically reduce the transparency characteristics. Further, the above problems become exacerbated when reinforcing fibers, such as glass fibers, are added to the polyester polymer composition. The reinforcing fibers, for instance, can also cause light scattering problems.

In view of the above, a need currently exists for a system and method of adding color to polymer compositions, particularly polyester compositions, in order for molded articles made from the composition to display a desired color while still having excellent light transparency characteristics that makes the molded article well suited for use in laser welding applications.

### SUMMARY

In general, the present disclosure is directed to a polyester polymer composition containing a blend of coloring agents that has excellent transparency properties at certain wavelengths of light. For example, the polymer composition of the present disclosure can be formulated to be laser transparent for use in a laser transmission welding procedure.

In one embodiment, the present disclosure is directed to a laser transparent composition comprising at least one polyester polymer. The polyester polymer can comprise a polybutylene terephthalate polymer. The polybutylene terephthalate polymer, for instance, can be present in the polymer composition in an amount greater than about 30% by weight, such as in an amount greater than about 45% by weight, such as in an amount greater than about 50% by weight, and generally in an amount less than about 95% by weight.

In accordance with the present disclosure, the polymer composition further contains a plurality of colored dyes. The dyes include a blue dye, a yellow dye, and a red dye. The dyes are combined together in ratios and are present in the polymer composition in an amount sufficient for the polymer composition to display a black color or a dark shade. The plurality of colored dyes are also incorporated into the polymer composition without significantly interfering with the light transparency properties of the polymer composition. In this regard, the polymer composition can have an average laser transmission of at least 3.5% when measured at a wavelength of 850 nm and at a thickness of 1 mm.

Various different colored dyes can be incorporated into the polymer composition. In one aspect, the colored dyes comprise polycyclic aromatic hydrocarbons. For instance, the colored dyes can comprise nitrogen-containing polycyclic aromatic hydrocarbons having ketone groups. In one aspect, the blue dye comprises an anthraquinone. The yellow dye can comprise a quinoline. The red dye, on the other hand, can comprise an amino ketone. Each dye can be present in the polymer composition in an amount from about 0.01% by weight to about 0.8% by weight. The blue dye can be present in the polymer composition in relation to the yellow dye at a weight ratio of from about 1.8:1 to about 1:1.8. The blue dye can be present in the polymer composition in relation to the red dye at a weight ratio of from about 3:1 to about 6:1.

Various other components and ingredients can be incorporated into the polymer composition. For example, in one aspect, the polymer composition can contain a second polyester polymer. The second polyester polymer can comprise a polyethylene terephthalate polymer. The polymer composition can also optionally contain reinforcing fibers, such as glass fibers. The reinforcing fibers can be present in the polymer composition in an amount from about 5% by weight to about 55% by weight, such as in an amount from about 8% by weight to about 42% by weight.

The present disclosure is also directed to molded articles formed from the polymer composition as described above. In addition, the present disclosure is directed to an assembly in which the molded article has been laser welded to an adjacent component.

All different types of products can be made in accordance with the present disclosure. In one aspect, the present disclosure is directed to a housing for a sensor, wherein the housing is formed from the polymer composition as described above. The sensor, for instance, can be part of an advanced driver assistance system.

The present disclosure is also directed to a method for attaching a polymer article to an adjacent surface. The method includes contacting a molded article made from the laser transparent composition as described above with a laser beam. The laser beam propagates through the molded article and contacts an adjacent surface formed from a laser weldable polymer composition. The laser beam causes a localized temperature increase at the adjacent surface sufficient for the adjacent surface to weld to the molded article.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view illustrating a laser welding process that may occur in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

Polyester polymer compositions, particularly fiber reinforced polybutylene terephthalate compositions, combine a wide range of desirable physical, mechanical, and electrical properties with excellent chemical and environmental resistance. Polyester compositions are used in all different types of applications and represent one of the fastest growing markets for use in producing advanced drive assistance systems. Polyester compositions, for instance, are well suited for producing all different types of electrical sensors. In these applications, the preferred method for assembling the different components is to use laser welding. For instance, the use of laser transmission welding, for instance, has recently grown significantly in popularity. During laser transmission welding, two joining partners are brought in contact and held together. The assembly includes an upper part and a lower part. The upper part of the assembly is formulated to be transparent to the wavelength at which the irradiating laser operates. The lower part, however, is formulated to be laser absorbent. In this manner, the laser can pass through the upper part and be absorbed by the lower part, which results in localized heating at the interface of the two parts resulting in the melting of both parts due to thermal conduction.

For many applications, particularly when constructing sensors, the components produced from polymer compositions and used in laser welding applications preferably display a dark color, and particularly a black color. Darker colored components, for instance, improve aesthetics and can also improve performance of the part, especially when the component emits any type of light signal. Creating a molded component from a polyester polymer composition that has a dark shade or black color and allows light, particularly laser light, to transmit therethrough is problematic. Many inorganic and organic colorants, for instance, absorb and/or reflect light at wavelengths at which lasers operate which can significantly diminish the transparency characteristics of the molded part. The present disclosure is directed to using a particular combination of coloring agents at controlled ratios that not only produces a dark shade or black color but also permits light to transmit through the molded article. In fact, the combination of coloring agents in accordance with the present disclosure produces molded parts having excellent transparency characteristics that further permit the inclusion of reinforcing fibers, such as glass fibers, while still having sufficient light transparent properties needed for laser welding applications.

The polymer composition of the present disclosure generally contains at least one polyester polymer, optionally reinforcing fibers, and a blend of coloring agents. The polyester polymer can be a polybutylene terephthalate polymer. The polybutylene terephthalate polymer can be present in the polymer composition generally in an amount greater than about 30% by weight, such as in an amount greater than about 35% by weight, such as in an amount greater than about 45% by weight, such as in an amount greater than about 55% by weight, such as in an amount greater than about 65% by weight, and generally in an amount less than about 95% by weight, such as in an amount less than about 90% by weight, such as in an amount less than about 80% by weight.

In one embodiment, the polymer composition only contains a single polyester polymer that is a polybutylene terephthalate polymer. Alternatively, other polyester polymers may be present in the polymer composition. For example, in one aspect, a polybutylene terephthalate polymer can be combined with a polyethylene terephthalate polymer. In addition to at least one polyester polymer, the polymer composition can optionally contain reinforcing fibers, such as glass fibers. In accordance with the present disclosure, the polymer composition further contains a plurality of coloring agents, particularly colored dyes. The colored dyes are blended together in amounts and at ratios so as to impart a dark color, such as a black color, to the polymer composition without degrading the light transparent properties of the composition. For example, the plurality of colored dyes can be added to the polymer composition without causing laser transmission (e.g. measured at a wavelength of 850 nm) to decrease by more than about 40%, such as by no more than about 30%, such as by no more than about 25%, such as by no more than about 20%.

At a wavelength of 850 nm, for instance, polyester polymer compositions, particularly polyester polymer compositions containing glass fibers, display a laser transmission of about 4%. Polymer compositions formulated in accordance with the present disclosure can display a laser transmission of greater than about 3%, such as greater than about 3.2%, such as greater than about 3.4%, such as greater than about 3.6%, and generally less than about 40%, such as less than about 20%, such as less than about 10%. As used herein, laser transmission is measured using an LPKF LQ-TMG 2 transmission tester operating at 850 nm. Molded plaques measuring 80 mm×80 mm×1 mm were placed on the tester and the amount of laser transmission through the samples was measured.

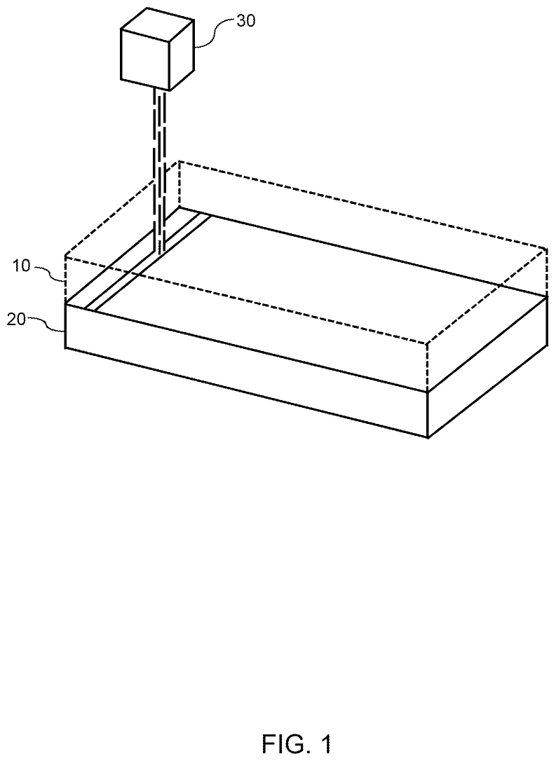

Referring to FIG. 1, for purposes of explanation only, a diagram is presented that displays a transmission welding process. Referring to FIG. 1, an assembly is shown including a first molded part 10 placed adjacent to a second molded part 20. Also illustrated is a laser device 30 that emits a laser beam 40. As shown in FIG. 1, in this embodiment, the laser 30 moves across the width of the first molded part 10 and the second molded part 20. The first molded part 10 is relatively transparent to the laser beam 40 while the second molded part 20 is formulated to absorb the laser beam. In this manner, as shown in FIG. 1, a substantial portion of the laser beam 40 travels through the first molded part 10 and contacts the second molded part 20. The second molded part 20 then absorbs the laser energy and undergoes a localized temperature increase that causes both the first molded part 10 and the second molded part 20 to melt and bond together.

In the embodiment illustrated in FIG. 1, the first molded part 10 is shown to be translucent in order to better illustrate the laser transmission process. Polymer compositions in accordance with the present disclosure, however, are formulated to have a dark shade or black color.

As described above, the polymer composition generally contains a thermoplastic polymer and particularly a polyester polymer. The polyesters which are suitable for use herein are derived from an aliphatic or cycloaliphatic diol, or mixtures thereof, containing from 2 to about 10 carbon atoms and an aromatic dicarboxylic acid, i.e., polyalkylene terephthalates.

The polyesters which are derived from a cycloaliphatic dial and an aromatic dicarboxylic acid are prepared by condensing either the cis- or trans-isomer (or mixtures thereof) of, for example, 1,4-cyclohexanedimethanol with the aromatic dicarboxylic acid.

Examples of aromatic dicarboxylic acids include isophthalic or terephthalic acid, 1,2-di(p-carboxyphenyl)ethane, 4,4′-dicarboxydiphenyl ether, etc., and mixtures of these. All of these acids contain at least one aromatic nucleus. Fused rings can also be present such as in 1,4- or 1,5- or 2,6-naphthalene-dicarboxylic acids. In one embodiment, the dicarboxylic acid is terephthalic acid or mixtures of terephthalic and isophthalic acid.

Polyesters that may be used in the polymer composition, for instance, include polyethylene terephthalate, polybutylene terephthalate, mixtures thereof and copolymers thereof.

In one aspect, the polyester polymer, such as the polybutylene terephthalate polymer, contains a relatively minimum amount of carboxyl end groups. For instance, the polyester polymer can contain carboxyl end groups in an amount less than about 20 mmol/kg, such as less than about 18 mmol/kg, such as less than about 15 mmol/kg, and generally greater than about 1 mmol/kg. The amount of carboxyl end groups can be minimized on the polyester polymer using different techniques. For example, in one embodiment, the polyester polymer can be contacted with an alcohol, such as benzyl alcohol, for decreasing the amount of carboxyl end groups, or an epoxy resin, such as 2,2-bis(p-glycidyloxyphenyl) propane condensation product with 2,2-bis(p-hydroxyphenyl) propane and similar isomers, respectively phenol, 4,4′-(1-methylethylidene)bis-, polymer with 2,2′[(I-methylethylidene)bis(4,1-phenyleneoxymethylene)]bis(oxirane).

As described above, the polymer composition may contain a mixture of polyester polymers. For instance, the polymer composition may contain a polybutylene terephthalate polymer combined with a second polyester polymer, such as a polyethylene terephthalate polymer. For example, the polybutylene terephthalate polymer may be contained in the polymer composition in an amount from about 35% to about 85% by weight, such as in an amount from about 40% to about 70% by weight. The polyethylene terephthalate polymer, on the other hand, may be present in the polymer composition generally in an amount greater than about 5% by weight, such as in an amount greater than about 10% by weight, such as in an amount greater than about 15% by weight, and generally in an amount less than about 35% by weight, such as in an amount less than about 30% by weight, such as in an amount less than about 25% by weight.

The polyester polymer or polybutylene terephthalate polymer can generally have a melt flow rate of greater than about 9 cm³/10 min, such as greater than about 15 cm³/10 min, such as greater than about 20 cm³/10 min, and generally less than about 120 cm³/10 min, such as less than about 100 cm³/10 min, such as less than about 70 cm³/10 min, such as less than about 50 cm³/10 min, when tested at 250° C. and at a load of 2.16 kg.

As described above, in accordance with the present disclosure, the one or more polyester polymers are combined with a plurality of coloring agents, particularly colored dyes. More particularly, the plurality of colored dyes includes a blue dye, a yellow dye, and a red dye. The three dyes are combined together at particular weight ratios and incorporated into the polymer composition in an amount that produces molded products having a dark shade, a dark color, and/or display a black color. The dyes are also combined and incorporated into a polymer composition without significantly degrading the laser transmission properties of the polymer composition, especially at the wavelength range in which lasers operate.

Although any suitable dye can be incorporated into the polymer composition, in one embodiment, the dyes are all derived from organic compounds. The dyes can also be solvent dyes. In one aspect, for instance, the colored dyes can comprise one or more polycyclic aromatic hydrocarbons. For example, the dyes can comprise nitrogen-containing polycyclic aromatic hydrocarbons having ketone groups.

In one aspect, for instance, the blue dye comprises solvent blue 104. The blue dye, for instance, can comprise an anthraquinone. In general, the blue dye can be incorporated into the polymer composition in an amount greater than about 0.01% by weight, such as in an amount greater than about 0.08% by weight, such as in an amount greater than about 0.1% by weight, such as in an amount greater than about 0.13% by weight. The blue dye can be incorporated into the polymer composition generally in an amount less than about 0.8% by weight, such as in an amount less than about 0.5% by weight, such as in an amount less than about 0.4% by weight, such as in an amount less than about 0.35% by weight.

In one embodiment, the yellow dye incorporated into the polymer composition is solvent yellow 33. The yellow dye, for instance, can comprise a quinoline. The yellow dye can be incorporated into the polymer composition in an amount greater than about 0.01% by weight, such as in an amount greater than about 0.08% by weight, such as in an amount greater than about 0.1% by weight, such as in an amount greater than about 0.13% by weight. The yellow dye can be incorporated into the polymer composition generally in an amount less than about 0.8% by weight, such as in an amount less than about 0.5% by weight, such as in an amount less than about 0.4% by weight, such as in an amount less than about 0.35% by weight, such as in an amount less than about 0.3% by weight.

The red dye incorporated into the polymer composition can also comprise an organic solvent dye. For example, the red dye can be solvent red 179. The red dye can be, for instance, an amino ketone. In one particular aspect, the red dye can comprise 14H-benz[4,5]isoquino[2,1,-a]perimidin-14-one. In one aspect, the red dye can be present in the polymer composition in an amount less than the blue dye and in an amount less than the yellow dye. For example, the red dye can be present in the polymer composition in an amount less than about 0.13% by weight, such as in an amount less than about 0.1% by weight, such as in an amount less than about 0.08% by weight. The red dye is present in the polymer composition generally in an amount greater than about 0.005% by weight, such as in an amount greater than about 0.008% by weight, such as in an amount greater than about 0.01% by weight.

The weight ratio between the different dyes can be controlled in order to produce a particular color while still preserving the laser transmission properties of the material. For example, the blue dye can be present in the polymer composition in relation to the yellow dye at a weight ratio of from about 1.8:1 to about 1:1.8, such as from about 1.5:1 to about 1:1.5, such as at a weight ratio of from about 1.2:1 to about 1:1.2. The blue dye can be present in the polymer composition in relation to the red dye at a weight ratio of from about 3:1 to about 6:1, such as from about 3.5:1 to about 5:1, such as from about 3.8:1 to about 4.8:1.

When incorporating the plurality of coloring agents into the polymer composition, in one embodiment, the coloring agents can first be combined with a carrier polymer to produce a masterbatch that is then combined with the other components. The carrier polymer, for instance, can be a polyester polymer, such as a polybutylene terephthalate polymer. In one embodiment, the blue dye and the yellow dye can be incorporated into the masterbatch in an amount greater than about 2% by weight, such as in an amount greater than about 3% by weight, such as in an amount greater than about 4% by weight, such as in an amount greater than about 5% by weight, and generally in an amount less than about 15% by weight, such as in an amount less than about 10% by weight, such as in an amount less than about 8% by weight, such as in an amount less than about 7% by weight. The red dye, on the other hand, can be incorporated into the masterbatch in an amount greater than about 0.5% by weight, such as in an amount greater than about 0.8% by weight, such as in an amount greater than about 1% by weight, and generally in an amount less than about 8% by weight, such as in an amount less than about 5% by weight, such as in an amount less than about 3% by weight, such as in an amount less than about 2% by weight. The masterbatch can contain the carrier polymer, such as a polyester polymer, generally in an amount greater than about 75% by weight, such as in an amount greater than about 80% by weight, such as in an amount greater than about 85% by weight, and generally in an amount less than about 95% by weight, such as in amount less than about 93% by weight, such as in an amount less than about 90% by weight.

The polymer composition may also contain reinforcing fibers dispersed in the thermoplastic polymer matrix. Reinforcing fibers of which use may advantageously be made are mineral fibers, such as glass fibers or polymer fibers, in particular organic high-modulus fibers, such as aramid fibers.

These fibers may be in a modified or unmodified form, e.g. provided with a sizing, or chemically treated, in order to improve adhesion to the plastic. Glass fibers are particularly preferred.

The reinforcing fibers, such as the glass fibers, can be coated with a sizing composition to protect the fibers and to improve the adhesion between the fiber and the matrix material. A sizing composition usually comprises silanes, film forming agents, lubricants, wetting agents, adhesive agents, optionally antistatic agents and plasticizers, emulsifiers and optionally further additives.

Specific examples of silanes are aminosilanes, e.g. 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Film forming agents are for example polyvinylacetates, polyesters and polyurethanes.

The sizing composition applied to the reinforcing fibers can contain not only a silane sizing agent but can also contain a hydrolysis resistant agent. The hydrolysis resistant agent, for instance, can be a glycidyl ester type epoxy resin. For instance, the glycidyl ester type epoxy resin can be a monoglycidyl ester or a diglycidyl ester. Examples of glycidyl ester type epoxy resins that may be used include acrylic acid glycidyl ester, a methacrylic acid glycidyl ester, a phthalic acid diglycidyl ester, a methyltetrahydrophthalic acid diglycidyl ester, or mixtures thereof.

In one aspect, the sizing composition contains a silane, a glycidyl ester type epoxy resin, a second epoxy resin, a urethane resin, an acrylic resin, a lubricant, and an antistatic agent. The second type of epoxy resin, for instance, can be a bisphenol A type epoxy resin. The hydrolysis resistant agent can be present in the sizing composition in relation to the silane sizing agent at a weight ratio of from about 5:1 to about 1:1, such as from about 4:1 to about 2:1.

The reinforcing fibers may be compounded into the polymer matrix, for example in an extruder or kneader.

Fiber diameters can vary depending upon the particular fiber used and whether the fiber is in either a chopped or a continuous form. The fibers, for instance, can have a diameter of from about 5 μm to about 100 μm, such as from about 5 μm to about 50 μm, such as from about 5 μm to about 12 μm. The length of the fibers can vary depending upon the particular application. For instance, the fibers can have an average length of greater than about 0.5 mm, such as greater than about 1 mm, such as greater than about 1.5 mm, such as greater than about 2.5 mm. The length of the fibers can generally be less than about 8 mm, such as less than about 7 mm, such as less than about 5.5 mm, such as less than about 4 mm.

In general, reinforcing fibers are present in the polymer composition in amounts sufficient to increase the tensile strength of the composition. The reinforcing fibers, for example, can be present in the polymer composition in an amount greater than about 2% by weight, such as in an amount greater than about 5% by weight, such as in an amount greater than about 10% by weight, such as in an amount greater than about 15% by weight, such as in an amount greater than about 20% by weight. The reinforcing fibers are generally present in an amount less than about 55% by weight, such as in an amount less than about 50% by weight, such as in an amount less than about 45% by weight, such as in an amount less than about 40% by weight, such as in an amount less than about 35% by weight, such as in an amount less than about 30% by weight.

In addition to one or more thermoplastic polymers, a blend of coloring agents, and optionally reinforcing fibers, the polymer composition of the present disclosure can optionally contain one or more nucleating agents. In one aspect, for instance, the nucleating agent can be a benzoate salt. The benzoate, for instance, can be an alkali or alkaline earth metal salt of benzoic acid. In one aspect, the nucleating agent can be sodium benzoate. Other nucleating agents that can be used include a salt of one or more carboxylic acids, such as a salt of one or more fatty acids. For example, the nucleating agent can comprise a salt of one or more aliphatic carboxylic acids. The carboxylic acids can have a relatively long carbon chain length. For instance, the carboxylic acids can have a carbon chain length of from about 14 carbon atoms to about 50 carbon atoms, such as from about 24 carbon atoms to about 34 carbon atoms. The carboxylic acids can be aliphatic and linear. The salt of the carboxylic acids can be an alkali or alkaline earth metal salt. In one particular embodiment, the nucleating agent can be a salt of montanic acid, such as a sodium salt of montanic acid and/or a calcium salt of montanic acid. The montanic acid may include a blend of carboxylic acids having a carbon chain length of from about 24 carbon atoms to about 34 carbon atoms, such as from about 28 carbon atoms to about 32 carbon atoms.

In another embodiment, the nucleating agent can be a sodium salt of a phosphorus compound. Suitable types of sodium salt nucleating agents include 2,4,8,10-Tetra(tert-buty)-6-hydroxy-12H-dibenzo[d,g][1,3,2]dioxaphosphocin 6-oxide, sodium salt.

In another aspect, the nucleating agent can comprise a sorbitol. Sorbitol-based nucleating agents include 1,3:2,4 Dibenzylidene sorbitol, 1,3:2,4 Di(methylbenzylidene) sorbitol, 1,3:2,4 Di(ethylbenzylidene) sorbitol, and 1,3:2,4 Bis(3,4-dimethylbenzylidene) sorbitol.

Each nucleating agent can be present in the polymer composition in an amount less than about 3% by weight, such as in an amount less than about 1.5% by weight, such as in an amount less than about 1.2% by weight, such as in an amount less than about 0.8% by weight, and generally in an amount greater than about 0.05% by weight, such as in an amount greater than about 0.1% by weight, such as in an amount greater than about 0.15% by weight.

In one aspect, the polyester polymer composition can contain a carbodiimide compound. The carbodiimide compound can have a carbodiimide group (—N═C═N—) in the molecule. The carbodiimide compound can provide hydrolysis resistance. Applicable carbodiimide compounds include an aliphatic carbodiimide compound having an aliphatic main chain, an alicyclic carbodiimide compound having an alicyclic main chain, and an aromatic carbodiimide compound having an aromatic main chain.

Examples of the aliphatic carbodiimide compounds include diisopropyl carbodiimide, dioctyldecyl carbodiimide, or the like. An example of the alicyclic carbodiimide compound includes dicyclohexyl carbodiimide, or the like.

Examples of aromatic carbodiimide compounds include: a mono- or di-carbodiimide compound such as diphenyl carbodiimide, di-2,6-dimethylphenyl carbodiimide, N-tolyl-N′-phenyl carbodiimide, di-p-nitrophenyl carbodiimide, di-p-aminophenyl carbodiimide, di-p-hydroxyphenyl carbodiimide, di-p-chlorophenyl carbodiimide, di-p-methoxyphenyl carbodiimide, di-3,4-dichlorophenyl carbodiimide, di-2,5-dichlorophenyl carbodiimide, di-o-chlorophenyl carbodiimide, p-phenylene-bis-di-o-tolyl carbodiimide, p-phenylene-bis-dicyclohexyl carbodiimide, p-phenylene-bis-di-p-chlorophenyl carbodiimide or ethylene-bis-diphenyl carbodiimide; and a polycarbodiimide compound such as poly(4,4′-diphenylmethane carbodiimide), poly(3,5′-dimethyl-4,4′-biphenylmethane carbodiimide), poly(p-phenylene carbodiimide), poly(m-phenylene carbodiimide), poly(3,5′-dimethyl-4,4′-diphenylmethane carbodiimide), poly(naphthylene carbodiimide), poly(1,3-diisopropylphenylene carbodiimide), poly(l-methyl-3,5-diisopropylphenylene carbodiimide), poly(1,3,5-triethylphenylene carbodiimide) or poly(triisopropylphenylene carbodiimide). These compounds can be used in combination of two or more of them. Among these, specifically preferred ones to be used are di-2,6-dimethylphenyl carbodiimide, poly(4,4′-diphenylmethane carbodiimide), poly(phenylene carbodiimide), and poly(triisopropylphenylene carbodiimide).

In one aspect, the carbodiimide compound is a polycarbodiimide. For instance, the polycarbodiimide can have a weight average molecular weight of about 10,000 g/mol or greater and generally less than about 100,000 g/mol. Examples of polycarbodiimides include Stabaxol KE9193 and Stabaxol P100 by Lanxess and Lubio AS3-SP by Schaeffe Additive Systems.

The carbodiimide compound can be present in the polymer composition in an amount greater than about 0.3% by weight, such as in an amount greater than about 0.8% by weight, and generally in an amount less than about 4% by weight, such as in an amount less than about 3% by weight, such as in an amount less than about 1.8% by weight.

The polymer composition may also contain one or more lubricants. For instance, fatty acid esters may be present as lubricants. Fatty acid esters may be obtained by oxidative bleaching of a crude natural wax and subsequent esterification of the fatty acids with an alcohol. The alcohol typically has 1 to 4 hydroxyl groups and 2 to 20 carbon atoms. When the alcohol is multifunctional (e.g., 2 to 4 hydroxyl groups), a carbon atom number of 2 to 8 is particularly desired. Particularly suitable multifunctional alcohols may include dihydric alcohol (e.g., ethylene glycol, propylene glycol, butylene glycol, 1,3-propanediol, 1,4-butanediol, 1,6-hexanediol and 1,4-cyclohexanediol), trihydric alcohol (e.g., glycerol and trimethylolpropane), tetrahydric alcohols (e.g., pentaerythritol and erythritol), and so forth. Aromatic alcohols may also be suitable, such as o-, m- and p-tolylcarbinol, chlorobenzyl alcohol, bromobenzyl alcohol, 2,4-dimethylbenzyl alcohol, 3,5-dimethylbenzyl alcohol, 2,3,5-cumobenzyl alcohol, 3,4,5-trimethylbenzyl alcohol, p-cuminyl alcohol, 1,2-phthalyl alcohol, 1,3-bis(hydroxymethyl)benzene, 1,4-bis(hydroxymethyl)benzene, pseudocumenyl glycol, mesitylene glycol and mesitylene glycerol. Particularly suitable fatty acid esters for use in the present invention are derived from montanic waxes. For instance, montanic acids can be partially esterified with butylene glycol and montanic acids can be partially saponified with calcium hydroxide. In one aspect, the lubricant can be an ester of a montanic acid in combination with a polyol.

Other known waxes may also be employed as a lubricant. Amide waxes, for instance, may be employed that are formed by reaction of a fatty acid with a monoamine or diamine (e.g., ethylenediamine) having 2 to 18, especially 2 to 8, carbon atoms. For example, ethylenebisamide wax, which is formed by the amidization reaction of ethylene diamine and a fatty acid, may be employed. The fatty acid may be in the range from C₁₂ to C₃₀, such as from stearic acid (C₁₈ fatty acid) to form ethylenebisstearamide wax. Ethylenebisstearamide wax is commercially available from Lonza, Inc. under the designation Acrawax® C, which has a discrete melt temperature of 142° C. Other ethylenebisamides include the bisamides formed from lauric acid, palmitic acid, oleic acid, linoleic acid, linolenic acid, oleostearic acid, myristic acid and undecalinic acid. Still other suitable amide waxes are N-(2-hydroxyethyl)12-hydroxystearamide and N,N′-(ethylene bis)12-hydroxystearamide, which are commercially available from CasChem, a division of Rutherford Chemicals LLC, under the designations Paricin® 220 and Paricin® 285, respectively. Other waxes that may be used include polyethylene waxes.

One or more lubricants can be present in the polymer composition generally in an amount greater than about 0.1% by weight, such as in an amount greater than about 0.2% by weight, such as in an amount greater than about 0.8% by weight, such as in an amount greater than about 1% by weight. One or more lubricants are generally present in an amount less than about 5% by weight, such as in an amount less than about 4% by weight, such as in an amount less than about 3.5% by weight.

The polymer composition of the present disclosure can contain various other additives. For example, the polymer composition may contain at least one stabilizer. The stabilizer may comprise an antioxidant, a light stabilizer such as an ultraviolet light stabilizer, a thermal stabilizer, and the like.

Sterically hindered phenolic antioxidant(s) may be employed in the composition. Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl) ester (Cyanox® 1729); triethylene glycol bis(3-tert-butyl-4-hydroxy methylhydrocinnamate); hexamethylene bis(3,5-di-tert-butyl hydroxyhydrocinnamate (Irganox® 259); 1,2-bis(3 5,di-tert-butyl hydroxyhydrocinnamoyl)hydrazide (Irganox® 1024); 4,4′-di-tert-octyldiphenamine (Naugalube® 438R); phosphonic add, (3,5-di-tert-butyl-4-hydroxybenzyl)-,dioctadecyl ester (Irganox® 1093); 1,3,5-trimethyl-2,4,6-tris(3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenypethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol] (Irganox® 129); N N′-hexamethylenebis(3,5-di-tert-butyl-4-hydroxyhydrocinnamamide) (Irganox® 1098): diethyl (3,5-di-tert-butyl-4-hydroxybenxyl)phosphonate (Irganox® 1222); 4,4′-di-tert-octyldiphenylarnine (Irganox® 5057); N-phenyl-1-napthalenamine (Irganox® L 05); tris[2-tert-butyl-4-(3-ter-butyl-4-hydroxy-6-methylphenylthio)-5-methyl phenyl] phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); pentaerythrityl tetrakis[3-(3,5-di-tert-butyl-4-hydroxyphenyl)propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and so forth,

Some examples of suitable sterically hindered phenolic antioxidants for use in the present composition are triazine antioxidants having the following general formula:

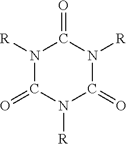

wherein, each R is independently a phenolic group, which may be attached to the triazine ring via a C₁, to C₅ alkyl or an ester substituent. Preferably, each R is one of the following formula (I)-(III):

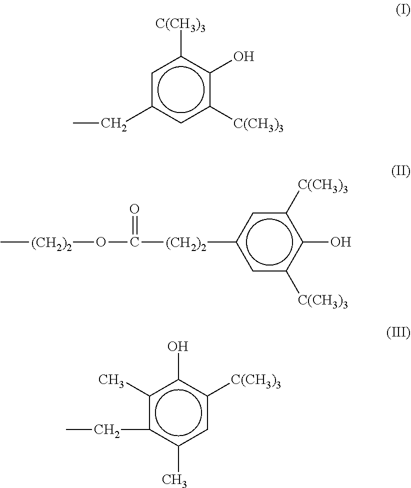

Commercially available examples of such triazine-based antioxidants may be obtained from American Cyanamid under the designation Cyanox® 1790 (wherein each R group is represented by the Formula III) and from Ciba Specialty Chemicals under the designations Irganox® 3114 (wherein each R group is represented by the Formula I) and Irganox® 3125 (wherein each R group is represented by the Formula II).

Sterically hindered phenolic antioxidants may constitute from about 0.01 wt. % to about 3 wt. %, in some embodiments from about 0.05 wt. % to about 1 wt. ° to, and in some embodiments, from about 0.05 wt. % to about 0.1 wt. % of the entire stabilized polymer composition. In one embodiment, for instance, the antioxidant comprises pentaerythrityl tetrakis[3-(3,5-di-tert-butyl-4-hydroxyphenyl)propionate.

Hindered amine light stabilizers (“HALS”) may be employed in the composition to inhibit degradation of the polyester composition and thus extend its durability. Suitable HALS compounds may be derived from a substituted piperidine, such as alkyl-substituted piperidyl, piperidinyl, piperazinone, alkoxypiperidinyl compounds, and so forth. For example, the hindered amine may be derived from a 2,2,6,6-tetraalkylpiperidinyl. Regardless of the compound from which it is derived, the hindered amine is typically an oligomeric or polymeric compound having a number average molecular weight of about 1,000 or more, in some embodiments from about 1000 to about 20,000, in some embodiments from about 1500 to about 15,000, and in some embodiments, from about 2000 to about 5000. Such compounds typically contain at least one 2,2,6,6-tetraalkylpiperidinyl group (e.g., 1 to 4) per polymer repeating unit.

Without intending to be limited by theory, it is believed that high molecular weight hindered amines are relatively thermostable and thus able to inhibit light degradation even after being subjected to extrusion conditions. One particularly suitable high molecular weight hindered amine has the following general structure:

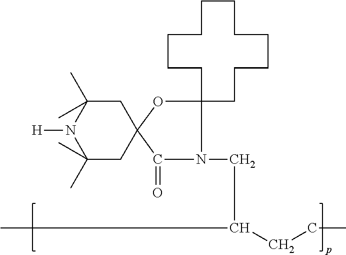

wherein, p is 4 to 30, in some embodiments 4 to 20, and in some embodiments 4 to 10. This oligomeric compound is commercially available from Clariant under the designation Hostavin® N30 and has a number average molecular weight of 1200.

Another suitable high molecular weight hindered amine has the following structure:

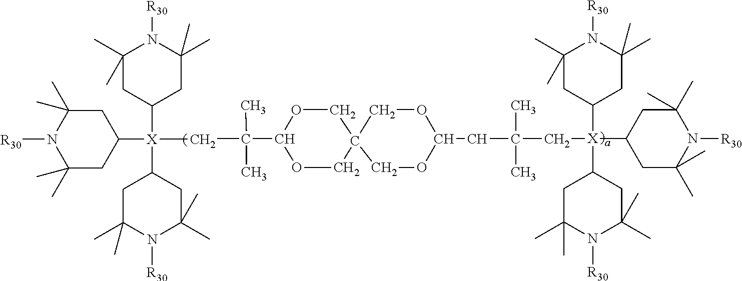

wherein, n is from 1 to 4 and R₃₀ is independently hydrogen or CH₃. Such oligomeric compounds are commercially available from Adeka Palmarole SAS (joint venture between Adeka Corp. and Palmarole Group) under the designation ADK STAB® LA-63 (R₃₀ is CH₃) and ADK STAB® LA-68 (R₃₀ is hydrogen).

Other examples of suitable high molecular weight hindered amines include, for instance, an oligomer of N-(2-hydroxyethyl)-2,2,6,6-tetramethyl-4-piperidinol and succinic acid (Tinuvin® 622 from Ciba Specialty Chemicals, MW=4000); oligomer of cyanuric acid and N,N-di(2,2,6,6-tetramethyl-4-piperidyl)-hexamethylene diamine; poly((6-morpholine-S-triazine-2,4-diyl)(2,2,6,6-tetramethyl-4-piperidinyl)-iminohexamethylene-(2,2,6,6-tetramethyl-4-piperidinyl)-imino) (Cyasorb® UV 3346 from Cytec, MW=1600); polymethylpropyl-3-oxy-[4(2,2,6,6-tetramethyl)-piperidinylysiloxane (Uvasil® 299 from Great Lakes Chemical, MW=1100 to 2500); copolymer of α-methylstyrene-N-(2,2,6,6-tetramethyl-4-piperidinyl)maleimide and N-stearyl maleimide; 2,4,8,10-tetraoxaspiro[5.5]undecane-3,9-diethanol tetramethyl-polymer with 1,2,3,4-butanetetracarboxylic acid; and so forth. Still other suitable high molecular weight hindered amines are described in U.S. Pat. No. 5,679,733 to Malik, et al. and U.S. Pat. No. 6,414,155 to Sassi, et al., which are incorporated herein in their entirety by reference thereto for all purposes.

In addition to the high molecular hindered amines, low molecular weight hindered amines may also be employed in the composition. Such hindered amines are generally monomeric in nature and have a molecular weight of about 1000 or less, in some embodiments from about 155 to about 800, and in some embodiments, from about 300 to about 800.

Specific examples of such low molecular weight hindered amines may include, for instance, bis-(2,2,6,6-tetramethyl-4-piperidyl) sebacate (Tinuvin® 770 from Ciba Specialty Chemicals, MW=481); bis-(1,2,2,6,6-pentamethyl-4-piperidinyl)-(3,5-ditert.butyl-4-hydroxybenzyl)butyl-propane dioate; bis-(1,2,2,6,6-pentamethyl-4-piperidinyl)sebacate; 8-acetyl-3-dodecyl-7,7,9,9-tetramethyl-1,3,8-triazaspiro-(4,5)-decane-2,4-dione, butanedioic acid-bis-(2,2,6,6-tetramethyl-4-piperidinyl) ester; tetrakis-(2,2,6,6-tetramethyl-4-piperidyl)-1,2,3,4-butane tetracarboxylate; 7-oxa-3,20-diazadispiro(5.1.11.2) heneicosan-20-propanoic acid, 2,2,4,4-tetramethyl-21-oxo, dodecyl ester; N-(2,2,6,6-tetramethyl-4-piperidinyl)-N′-amino-oxamide; o-t-amyl-o-(1,2,2,6,6-pentamethyl-4-piperidinyl)-monoperoxi-carbonate; β-alanine, N-(2,2,6,6-tetramethyl-4-piperidinyl), dodecylester; ethanediamide, N-(1-acetyl-2,2,6,6-tetramethylpiperidinyl)-N′-dodecyl; 3-dodecyl-1-(2,2,6,6-tetramethyl-4-piperidinyl)-pyrrolidin-2,5-dione; 3-dodecyl-1-(1,2,2,6,6-pentamethyl-4-piperidinyl)-pyrrolidin-2,5-dione; 3-dodecyl-1-(1-acetyl,2,2,6,6-tetramethyl-4-piperidinyl)-pyrrolidin-2,5-dione, (Sanduvar® 3058 from Clariant, MW=448.7); 4-benzoyloxy-2,2,6,6-tetramethylpiperidine, 1-[2-(3,5-di-tert-butyl hydroxyphenylpropionyloxy)ethyl]-4-(3,5-di-tert-butyl-4-hydroxyphenyl propionyloxy)-2,2,6,6-tetramethyl-piperidine; 2-methyl-2-(2″,2″,6″,6″-tetramethyl-4″-piperidinylamino)-N-(2′,2′,6′,6′-tetra-methyl-4′-piperidinyl)propionylamide; 1,2-bis-(3,3,5,5-tetramethyl-2-oxo-piperazinyl)ethane; 4-oleoyloxy-2,2,6,6-tetramethylpiperidine, and combinations thereof. Other suitable low molecular weight hindered amines are described in U.S. Pat. No. 5,679,733 to Malik, et al.

The hindered amines may be employed singularly or in combination in any amount to achieve the desired properties, but typically constitute from about 0.01 wt. % to about 4 wt. % of the polymer composition.

UV absorbers, such as benzotriazoles or benzopheones, may be employed in the composition to absorb ultraviolet light energy. Suitable benzotriazoles may include, for instance, 2-(2-hydroxyphenyl)benzotriazoles, such as 2-(2-hydroxy-5-methylphenyl)benzotriazole; 2-(2-hydroxy-5-tert-octylphenyl)benzotriazole (Cyasorb® UV 5411 from Cytec); 2-(2-hydroxy-3,5-di-tert-butylphenyl)-5-chlorobenzo-triazole; 2-(2-hydroxy-3-tert-butyl-5-methylphenyl)-5-chlorobenzotriazole; 2-(2-hydroxy-3,5-dicumylphenyl)benzotriazole; 2,2′-methylenebis(4-tert-octyl-6-benzo-triazolylphenol); polyethylene glycol ester of 2-(2-hydroxy-3-tert-butyl-5-carboxyphenyl)benzotriazole; 2-[2-hydroxy-3-(2-acryloyloxyethyl)-5-methylphenyl]-benzotriazole; 2-[2-hydroxy-3-(2-methacryloyloxyethyl)-5-tert-butylphenyl]benzotriazole; 2-[2-hydroxy-3-(2-methacryloyloxyethyl)-5-tert-octylphenyl]benzotriazole; 2-[2-hydroxy-3-(2-methacryloyloxyethyl)-5-tert-butylphenyl]-5-chlorobenzotriazole; 2-[2-hydroxy-5-(2-methacryloyloxyethyl)phenyl]benzotriazole; 2-[2-hydroxy-3-tert-butyl-5-(2-methacryloyloxyethyl)phenyl]benzotriazole; 2-[2-hydroxy-3-tert-amyl-5-(2-methacryloyloxyethyl)phenyl]benzotriazole; 2-[2-hydroxy-3-tert-butyl-5-(3-methacryloyloxypropyl)phenyl]-5-chlorobenzotriazole; 2-[2-hydroxy-4-(2-methacryloyloxymethyl)phenyl]benzotriazole; 2-[2-hydroxy-4-(3-methacryloyloxy hydroxypropyl)phenyl]benzotriazole; 2-[2-hydroxy-4-(3-methacryloyloxypropyl)phenyl]benzotriazole; and combinations thereof.

Exemplary benzophenone light stabilizers may likewise include 2-hydroxy-4-dodecyloxybenzophenone; 2,4-dihydroxybenzophenone; 2-(4-benzoyl-3-hydroxyphenoxy)ethyl acrylate (Cyasorb® UV 209 from Cytec); 2-hydroxy-4-n-octyloxy)benzophenone (Cyasorb® 531 from Cytec): 2,2′-dihydroxy-4-(octyloxy)benzophenone (Cyasorb® UV 314 from Cytec); hexadecyl-3,5-bis-tert-butyl-4-hydroxybenzoate (Cyasorb® UV 2908 from Cytec); 2,2′-thiobis(4-tert-octylphenolato)-n-butylamine nickel(II) (Cyasorb® UV 1084 from Cytec); 3,5-di-tert-butyl-4-hydroxybenzoic acid, (2,4-di-tert-butylphenyl)ester (Cyasorb® 712 from Cytec); 4,4′-dimethoxy-2,2′-dihydroxybenzophenone (Cyasorb® UV 12 from Cytec); and combinations thereof.

When employed, UV absorbers may constitute from about 0.01 wt. % to about 4 wt. % of the entire polymer composition.

Once formed, the polymer composition may be molded into a shaped part for use in a wide variety of different applications. For example, the shaped part may be molded using an injection molding process in which dried and preheated plastic granules can be injected into the mold.

The polymer composition and/or shaped molded part can be used in a variety of applications. For example, the molded part can be employed in lighting assemblies, battery systems, sensors and electronic components, portable electronic devices such as smart phones, MP3 players, mobile phones, computers, televisions, automotive parts, etc. In one particular embodiment, the molded part may be employed in a camera module, such as those commonly employed in wireless communication devices (e.g., cellular telephone). For example, the camera module may employ a base, carrier assembly mounted on the base, a cover mounted on the carrier assembly, etc. The base may have a thickness of about 500 micrometers or less, in some embodiments from about 10 to about 450 micrometers, and in some embodiments, from about 20 to about 400 micrometers. Likewise, the carrier assembly may have a wall thickness of about 500 micrometers or less, in some embodiments from about 10 to about 450 micrometers, and in some embodiments, from about 20 to about 400 micrometers.

In one aspect, the polymer composition of the present disclosure can be used to produce a housing for electronic devices. For instance, the polymer composition can be a housing for a sensor. In one particular embodiment, the sensor can be part of an advanced driver assistance system.

As described above, polymer articles made according to the present disclosure are particularly well suited for use in applications where laser transmission welding is utilized. Polymer articles made according to the present disclosure, for instance, have high transparency properties at wavelengths at which lasers operates. During laser welding, for instance, a laser beam can travel through molded articles made according to the present disclosure and contact an adjacent surface for forming a weld. The laser beam causes a localized temperature increase at the adjacent surface which causes polymer melting to occur and the formation of a weld. Of particular advantage, molded articles made according to the present disclosure are not only laser transparent but also have excellent mechanical properties. All different types of laser beams can be used during the laser transmission process. The laser, for instance, can be a laser diode.

The laser beam, for instance, can operate at a wavelength of light of greater than about 400 nm, such as greater than about 600 nm, such as greater than about 800 nm, and generally less than about 2000 nm, such as less than about 1800 nm.

The present disclosure may be better understood with reference to the following examples.

### Examples

Various different polymer compositions were formulated and tested for laser transmission.

Initially, a color masterbatch was produced having the following components:

| | Amount |
|---|---|
| Ingredients | (by weight) |
| Polybutylene | 87.87% |
| terephthalate polymer | |
| Solvent blue 104 | 5.73% |
| Solvent yellow 33 | 5.25% |
| Solvent red 179 | 1.15% |

The above color masterbatch was then combined with a polymer composition containing 50% by weight of a polybutylene terephthalate polymer, 20% by weight of a polyethylene terephthalate polymer, and 30% by weight of glass fibers. Various different amounts of the masterbatch were incorporated into the above composition and tested for laser transmission. The following results were obtained:

| | Sample | Sample | Sample | Sample | Sample |
|---|---|---|---|---|---|
| Ingredient | No. 1 | No. 2 | No. 3 | No. 4 | No. 5 |
| Color | 0% | 1% | 2% | 4% | 5% |
| masterbatch | | | | | |
| PBT/PET/ | 100% | 99% | 98% | 96% | 95% |
| glass fibers | | | | | |
| Average | 4.5 | 3.8 | 3.8 | 3.8 | 3.7 |
| laser | | | | | |
| transmission | | | | | |
| (%) | | | | | |
| Visual | White | Gray | Dark gray | Black | Black |
| evaluation | appearance | appearance | appearance | appearance | appearance |

As shown above, combining the three coloring agents produced a polymer composition having a black appearance with excellent laser transmission properties, suitable for laser welding applications.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A laser transparent composition comprising:
a polymer composition comprising at least one polyester polymer, the at least one polyester polymer comprising a polybutylene terephthalate polymer, the polymer composition further optionally comprising reinforcing fibers, the polymer composition containing a plurality of colored dyes, the dyes including a blue dye, a yellow dye and a red dye, the dyes being combined together in ratios and being present in the polymer composition in an amount sufficient for the polymer composition to display a black color, the polymer composition having an average laser transmission of at least 3.5% when measured at a wavelength of 850 nm and at a thickness of 1 mm.

2. A laser transparent composition as defined in claim 1, wherein the colored dyes comprise polycyclic aromatic hydrocarbons.

3. A laser transparent composition as defined in claim 2, wherein the colored dyes comprise nitrogen-containing polycyclic aromatic hydrocarbons having ketone groups.

4. A laser transparent composition as defined in claim 1, wherein the blue dye comprises an anthraquinone.

5. A laser transparent composition as defined in claim 1, wherein the yellow dye comprises a quinoline.

6. A laser transparent composition as defined in claim 1, wherein the red dye comprises an amino ketone.

7. A laser transparent composition as defined in claim 1, wherein the polymer composition contains a second polyester polymer, the second polyester polymer comprising a polyethylene terephthalate polymer.

8. A laser transparent composition as defined in claim 1, wherein the polymer composition contains the polybutylene terephthalate polymer in an amount of from about 35% by weight to about 85% by weight.

9. A laser transparent composition as defined in claim 1, wherein each dye is present in the polymer composition in an amount of from about 0.01% to about 0.8% by weight.

10. A laser transparent composition as defined in claim 1, wherein the blue dye is present in the polymer composition in relation to the yellow dye at a weight ratio of from about 1.8:1 to about 1:1.8.

11. A laser transparent composition as defined in claim 1, wherein the blue dye is present in the polymer composition in relation to the red dye at a weight ratio of from about 3:1 to about 6:1.

12. A laser weldable composition as defined in claim 1, wherein the reinforcing fibers are present in the polymer composition and comprise glass fibers.

13. A laser weldable composition as defined in claim 12, wherein the reinforcing fibers are present in the polymer composition in an amount from about 8% by weight to about 42% by weight.

14. A molded article formed from the polymer composition as defined in claim 1.

15. An assembly including the molded article as defined in claim 14, the molded article having been laser welded to an adjacent component.

16. A sensor comprising a housing, the housing being made from the polymer composition as defined in claim 1.

17. An advanced driver assistance system including the sensor as defined in claim 16.

18. A method for attaching a polymer article to an adjacent surface comprising:
contacting a molded article made from the laser transparent composition as defined in claim 1 with a laser beam, the laser beam propagating through the molded article and contacting an adjacent surface formed from a laser weldable polymer composition causing a localized temperature increase at the adjacent surface sufficient for the adjacent surface to weld to the molded article.
